(19) United States
(12) Patent Application Publication
(10) Pub. No.: US 2004/0222959 A1
(43) Pub. Date: Nov. 11, 2004

(54) Display driving system

(75) Inventors: Chang-Cheng Lin, Taipei (TW); Cheng-Chih Hsu, Ilan (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/632,917

(22) Filed: Aug. 4, 2003

(30) Foreign Application Priority Data
May 8, 2003 (TW) 092112536

(51) Int. Cl. G09G 3/36

(52) U.S. Cl. 345/98

(57) ABSTRACT

The present invention relates to a display driving system. In this system, a plurality of memories capable of synchronously being read and written are used as frame buffers. When the image data is transmitted to the memory, the memory will synchronously output the image data to the display device. Therefore, in the inventive system, the memory capacity required for driving can be reduced and the circuit and control system can be simplified.

This display driving system comprises a plurality of memories capable of synchronously being read and written to be used as buffers for frame accessing, an image signal generator for processing digital image, a timing controller for being a memory and for timing controlling, a plurality of data drivers for receiving the image data and displaying it on the display device.

### BACKGROUND OF THE INVENTION

1. Field of the Invention

The present invention relates to a display driving system. In this system, a plurality of memories capable of synchronously being read and written are used as image frame buffers so as to reduce the required memory capacity for driving and simplify the circuit and control system.

2. Description of the Prior Art

The charging time for the pixels of the conventional large size liquid crystal display device panel is insufficient due to the excessively great load of the scanning lines or data lines, and the relevant technology is developed in order to resolve this problem. In the prior art, a plurality of horizontal scanning lines are turned on at the same so as to increase the charging/discharging time of the horizontal scanning lines. Please refer to FIG. 1. FIG. 1 is a perspective diagram of starting timings of horizontal scanning lines in the prior art. The display device 100 is provided with 1200 horizontal scanning lines, and the scanning lines are divided into two sets. The display device 100 has a gate driver 103 for sequentially controlling the scanning lines on the panel to be ON/OFF, and all of the scanning lines are turned on during the period of one output pulse width. When the gate driver 103 turns on the first scanning line (denoted as 1) of the first set of scanning lines 101, the first line of the second set of scanning lines 102 of the display device 100, namely the 601th scanning line (denoted as 601), will be turned on synchronously. The following lines will be sequentially turned on until the last ones, namely the last scanning line (denoted as 600) of the first set of scanning lines 101 and the last scanning line (denoted as 1200) of the second set of scanning lines 102, are synchronously turned on. In other words, when the Nth scanning line is turned on, the 600+Nth one will be synchronously turned on until all operations of the scanning lines of the display device 100 are finished. Therefore, in this prior art, the charging time of the pixels on the display device 100 can be doubled.

In order to drive the prior art panel 100 in FIG. 1, a prior art display driving system in FIG. 2 is employed. When an image signal generator 209 for a processing signal source generates an image signal, the image signal will transmitted to the buffer area composed of memories via a bus 205. Then, the controller 207 will process this image signal and control it to be the accessing timing for the first buffer area 201 and second buffer area 202 of the frame buffer so as to access the image signal. The frame data of the first buffer area 201 is divided into two portions for being stored in two memories, namely, the first memory 201a and the second memory 201b. After the image data of the entire frame is stored in the first buffer area 201, the first memory 201a and the second memory 201b in the buffer area will separately transmit the data to the first data driver 200a and the second data driver 200b on the panel 200 via the bus 205. As shown in FIG. 2, the first data driver 200a is on the upper part of the panel 200 while the second data driver 200b is on the lower part. Next, the transmitted data will be synchronously displayed on the upper half portion and the lower half portion of the panel 200. The displaying timing is shown in FIG. 1. When the image data of the first buffer area 201 is being transmitted to the plurality of data drivers of the panel 200, this driving system further comprises a second buffer area 202 for synchronously receiving the image data transmitted by the image signal generator 209 via the bus 205. The second buffer area 202 is also divided into the first memory 202a and the second memory 202b for storing the frame data. When the image data in the first buffer area 201 is transmitted to the data driver, the first memory 202a and the second memory 202b of the second buffer area 202 will separately transmit the data to the first data driver 200a and the second data driver 200b of the panel 200 via the bus 205. At the same time, the first buffer area 201 will synchronously receive the frame data form the bus 205. After the image data in the second buffer area 202 is transmitted to the data driver of the panel 200, the image data will ten transmitted to the panel 200 via the bus 205.

The operation of transmitting the image frame to the data driver of the panel 200 by the first buffer area 201 and the second buffer area 202 in FIG. 2 will be repeatedly performed. When the first buffer area 201 finishes the transmission, the second buffer area 202 will transmit the image data. And when the second buffer area 202 is active, the next image data will be stored in the first buffer area 201, and the first buffer area 201 is inactive until the second buffer area 202 finishes the operation.

In the prior art, two dynamic memories with great capacities are required and a complex control circuit is needed. This will not only increase the cost, but also complicate the circuit. In order to resolve the mentioned problems, the present invention employs the memory capable of synchronously being read and written so as to reduce the required memory capacity for driving because of the simple control circuit and control method of the memory.

### SUMMARY OF THE INVENTION

The present invention relates to a display driving system. In this system, a plurality of memories capable of synchronously being read and written are used as frame buffers. When the image data is transmitted to the memory, the memory will synchronously output the image data to the display device. Therefore, in the inventive system, the memory capacity required for driving can be reduced and the circuit and control system can be simplified.

This display driving system comprises a plurality of memories capable of synchronously being read and written to be used as buffers for frame accessing, an image signal generator for processing digital image, a timing controller for being a memory and for timing controlling, a plurality of data drivers for receiving the image data and displaying it on the display device.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of starting timings of horizontal scanning lines in the prior art;

FIG. 2 is a perspective diagram of a prior art display driving system;

FIG. 3 is a perspective diagram of a display driving system according to an embodiment of the present invention;

FIG. 4 is a perspective diagram of starting timings of horizontal scanning lines of the display driving system according to the embodiment of the present invention; and

FIG. 5A to 5F are perspective diagrams of accessing operations for the memory of display driving system according to the embodiment of the present invention.

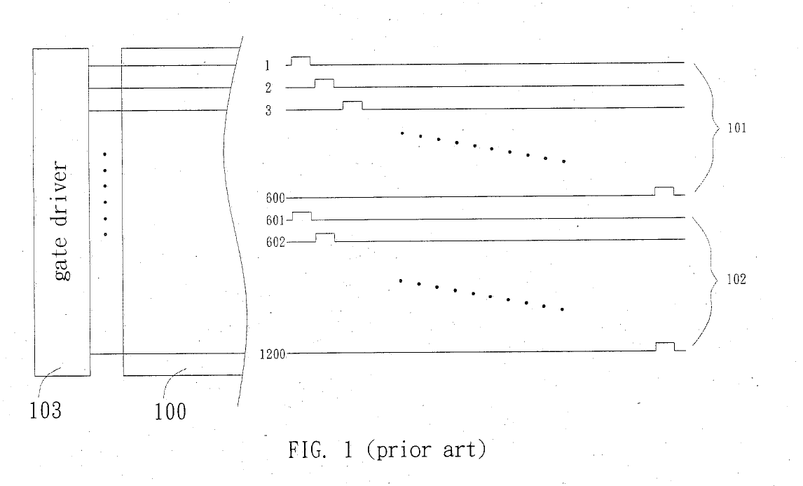

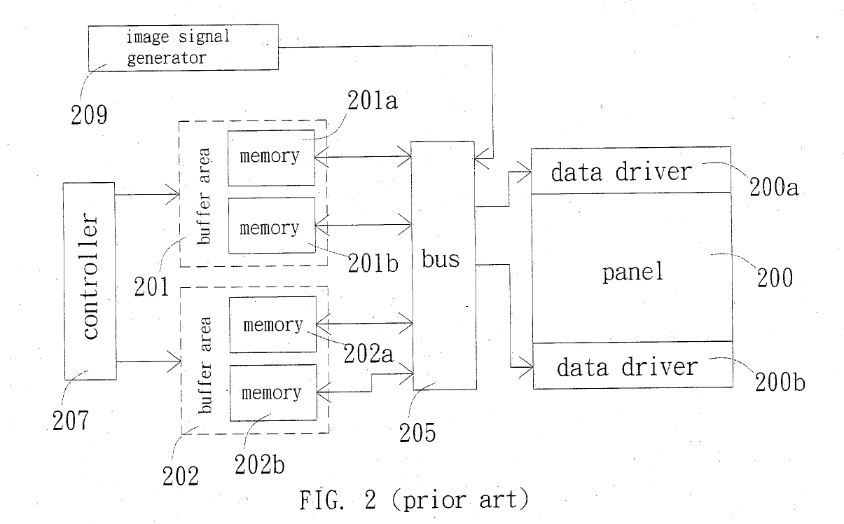

### DETAILED DESCRIPTION OF THE PREFERRED EMBODIMENT

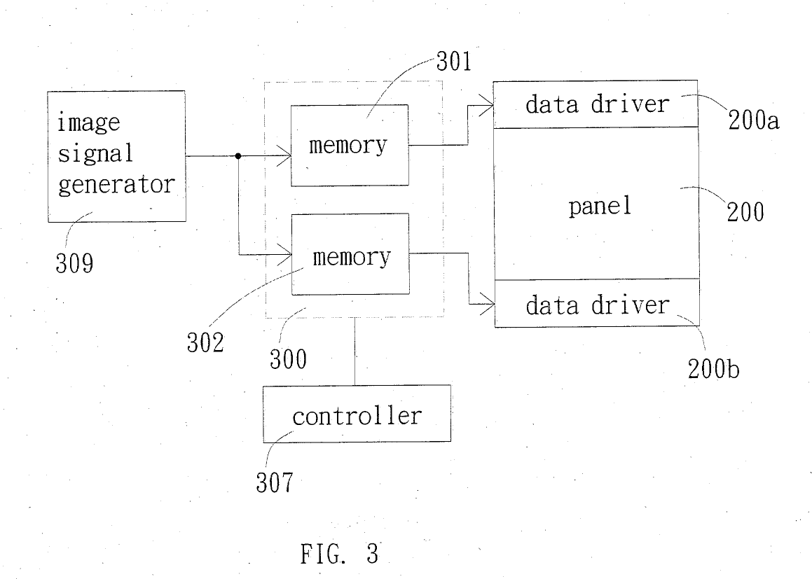

Please refer to FIG. 3. FIG. 3 is a perspective diagram of a display driving system according to an embodiment of the present invention. The driving system employs a plurality of memories (such as first-in first-out, FIFO) 300 capable of synchronously being read and written for being buffers for image data. The memories 300 comprise a first memory 301 and a second memory 302. Because they are capable of synchronously being read and written, the image data transmitted from the signal source is stored while the stored image data is outputted to the first data driver 200a and the second data driver 200b of the panel 200. When the operation for storing multiple data is performed, the multiple data can be outputted synchronously. Therefore, the same memory space for the frame data can be used repeatedly so as to reduce the required memory space.

When the image signal is transmitted to the system by the image signal generator 309 for the processing digital image signal source, according to the timing, the image data is stored in the first memory 301 or the second memory 302 capable of synchronously being read and written and used as data buffers. When the image data is transmitted to the memory 300 by the image signal generator 309 and a timing controller 307 controls the accessing timing of the memory 300, the first memory 301 will first access the data on the upper half portion of the frame. When the image data is transmitted, the in the memory can be synchronously outputted to the first data driver 200a of the panel 200 and then displayed on the panel 200 due to the characteristic of the memory for being capable of synchronously being read and written memory. If the image signal generator 309 finishes the transmission of the data on the upper half portion of the frame, the second memory 302 will synchronously output the image data to the second data driver 200b of the panel 200 even before the first memory 301 finishes the operation for outputting, namely the data on the lower half portion of the frame is sent to the second memory 302. If the image signal generator 309 finishes the operation of transmitting the image data on the lower half portion of the frame to the memory, it need not wait for the finishing of the operation for transmitting the data from the second memory 302 to the panel 200, and can immediately send the frame data on the upper half portion of the next image data to the first memory 301, which just finishes the operation for outputting the image data, so as to continue the transmission for the next fame.

FIG. 4 is a perspective diagram of starting timings of horizontal scanning lines of the display driving system according to the embodiment of the present invention. The driving system of the panel 200 employs the memories capable of synchronously being read and written to be the frame buffers. The gate driver 400 is used for controlling the starting timings of the horizontal scanning lines, and the panel 200 is divided into a first part 401 and a second part 402. The first part 401 is an upper portion while the second part 402 is a lower portion. Because the first part 401 and second part 402 are separately driven by different data drivers and accessed by two different memories capable of synchronously being read and written.

As shown in FIG. 4, the panel comprises 1200 scanning lines. When the panel 200 starts displaying the frame, the first memory 301 in FIG. 3 will start outputting the image data to the first part 401 of the panel in FIG. 4. The first scanning line (denoted as 1) to the last scanning line (denoted as 600) are sequentially turned on, and when one half of the scanning lines are turned on, the second memory 302 will output the image data to the lower half portion on the panel. As shown in FIG. 4, the first scanning line (denoted as 601) of the second part 402 is turned on when the half of the scanning lines on the upper half portion of the frame are turned on, and when the last scanning line (denoted as 1200) on the lower half portion is turned on, the half of the scanning lines on the upper half portion are turned on. And then synchronously, the first scanning line (denoted as 601) on the lower half portion will be immediately turned on, and the following scanning lines are sequentially turned on until the last scanning line. This is the characteristic of using the memories capable of synchronously being read and written as the frame buffers, and therefore, the circuit and control system are simplified so as to reduce the required memory space.

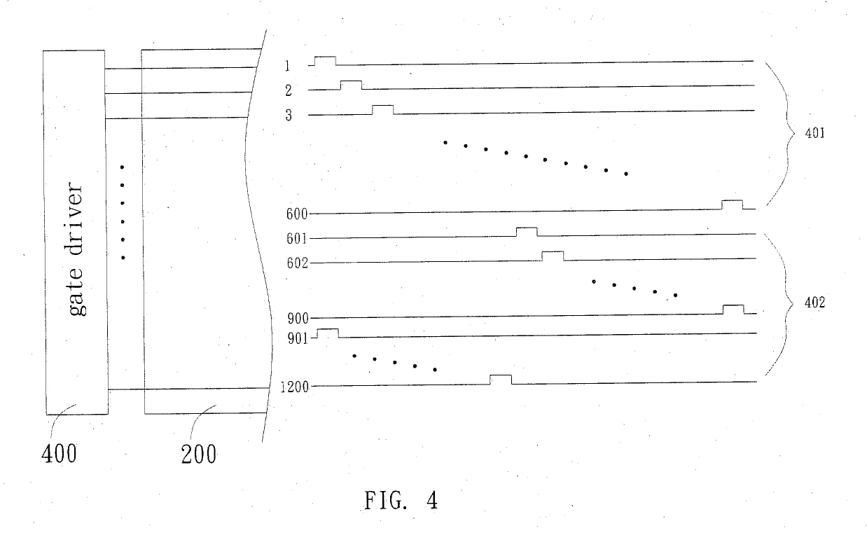

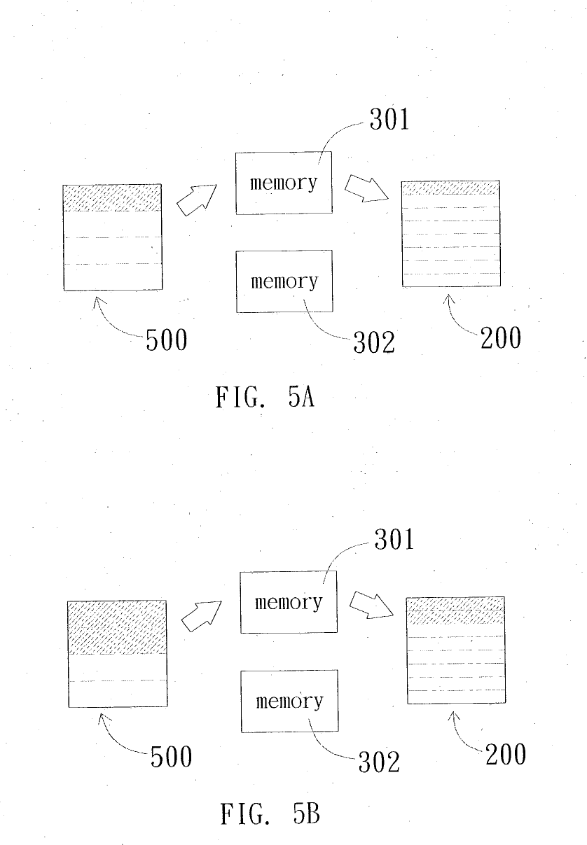

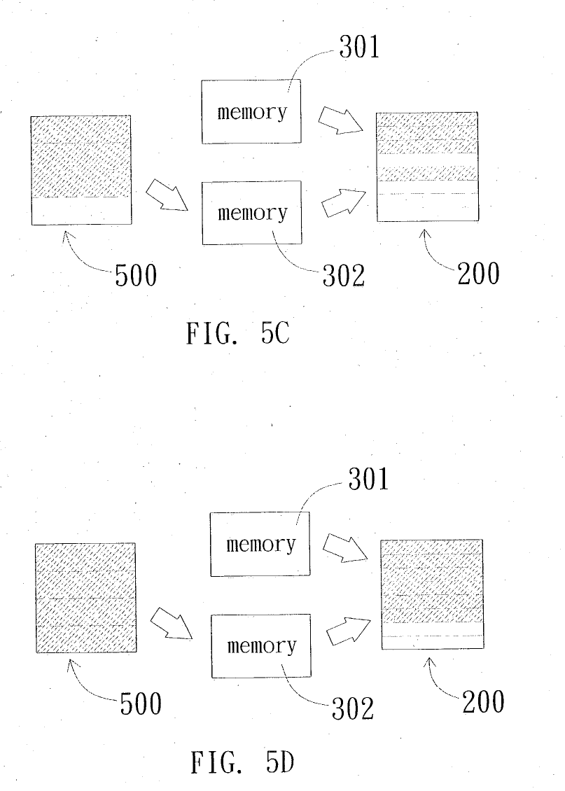

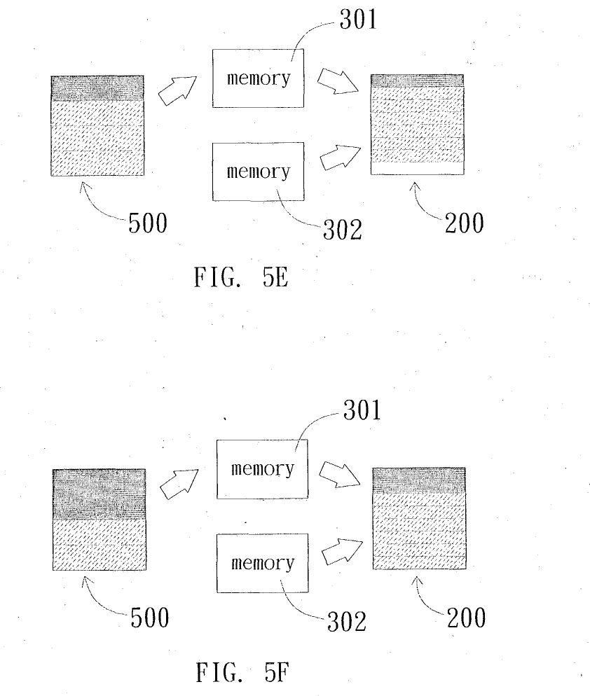

Please refer to FIG. 5A to 5F. FIG. 5A to 5F are perspective diagrams of accessing operations for the memory of display driving system according to the embodiment of the present invention. The inventive system employs the memory capable of synchronously being read and written to be the buffer for image data accessing, and the memory is divided into two portions. When the memory receives the image data, the image data will be synchronously outputted to the data driver of the panel. The timing controller is used for controlling the two portions of the memory so as to perform the operation of synchronously being read and written by turns. FIG. 5A shows the operation of processing an image signal into an image data source 500 by the image signal generator. The image data is first transmitted to the first memory 301, and at the same time, the first memory 301 capable of synchronously being read and written will output the received image data to the panel 200 for being displayed. As shown in FIG. 5A, the output amount of the image data by the memory is the half of the input amount of the image data. Next, FIG. 5B shows that the half data of the image data source 500 (namely the upper half portion of the frame) has been transmitted to the first memory 301, and the half of the image data of the first memory 301 is synchronously outputted to the panel 200. As shown in FIG. 5C, the data on the lower half portion of the image data source 500 is continuously transmitted to the second memory 302. At the same time, the first memory 301 will continuously output the image data on the upper half portion, and the second memory 302 will also synchronously output the just received image data on the lower half portion. Also, the output amount of the data is one half of the input amount. As shown in FIG. 5D, the first memory 301 finishes the outputting of the image data on the upper half portion, and the second memory 302 also finishes the receiving of the image data on the lower half portion and synchronously input the data to the panel 200. As shown in FIG. 5E, the second memory 302 will continuously output the image data to the panel 200, and the first memory 301 has started to receive the image data of the next frame from the image data source 500 and then synchronously output the data to the panel 200. FIG. 5F shows that the second memory 302 finishes the receiving of the image data and still continuously output the data to the panel 200, and as the same time, the first memory 301 will finishes the receiving the image data on the upper half portion and output the data to the panel 200. The process of accessing the image data by the memory, as shown in FIG. 5A to 5F, will be repeatedly performed so as to achieve the object of the present invention for reducing the required memory capacity and simplifying the circuit control.

The above is the detailed description of the display driving system according to the embodiment. The plurality of memories which are capable of synchronously being read and written are used as frame accessing buffers so as to reduce the required memory space and simplify the control circuit.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A display driving system capable of reducing the required memory space, and simplifying the control circuit, the system comprising:
a plurality of memories capable of synchronously being read and written for being used as buffers for frame accessing;
an image signal generator for processing the digital image;
a timing controller for controlling the plurality of memories capable of synchronously being read and written and the timing; and
a plurality of data drivers positioned on a display device panel for receiving the image data and displaying it on the panel.

2. The display driving system of claim 1, wherein the plurality of memories capable of synchronously being read and written are used for separately accessing the image data on the upper and lower half portions of the panel.

3. The display driving system of claim 1, wherein the output amount of the image data by the plurality of memories capable of synchronously being read and written is one half of the input amount of the image data.

4. A display driving system capable of reducing the required memory space and simplifying the control circuit, comprising:
a first memory for being a memory capable of synchronously being read and written;
a second memory for being a memory capable of synchronously being read and written;
an image signal generator for processing the digital image and being an image data source;
a timing controller for controlling the plurality of memories capable of synchronously being read and written and the timing;
a first data driver positioned on a display device panel for receiving the image data; and
a second data driver positioned on the display device panel for receiving the image data.

5. The display driving system of claim 4, wherein the first memory is connected to the first data driver.

6. The display driving system of claim 4, wherein the first memory is used for accessing the image data of the upper half portion of the panel.

7. The display driving system of claim 4, wherein the second memory is connected to the second data driver.

8. The display driving system of claim 4, wherein the second memory is used for accessing the image data of the lower half portion of the panel.

9. The display driving system of claim 1, wherein the output amount of the image data by the first memory and the second memory is a half of the input amount of the image data.
